(19) United States
(12) Patent Application Publication
(10) Pub. No.: US 2020/0029194 A1
(43) Pub. Date: Jan. 23, 2020

(54) REPORTING LIGHT METHOD AND APPARATUS

(71) Applicant: J.W. SPEAKER CORPORATION, Germantown, WI (US)

(72) Inventor: Timothy Speaker, Germantown, WI (US)

(21) Appl. No.: 16/513,053

(22) Filed: Jul. 16, 2019

Related U.S. Application Data
(60) Provisional application No. 62/699,445, filed on Jul. 17, 2018.

(51) Int. Cl. H04W 4/90; H04W 4/029; H04W 4/02; B60Q 1/04; B60Q 1/00

(52) U.S. Cl. CPC H04W 4/90; H04W 4/029; B60Q 1/0023; B60Q 1/04; H04W 4/027

(57) ABSTRACT

A headlight assembly for use in a vehicle and for reporting emergency conditions to a dispatcher, the headlight assembly comprising a housing forming a cavity, a processor mounted in the cavity, a wireless transceiver supported by the housing and linked to the processor, at least a first sensor device for sensing at least a first condition while the vehicle is operating, the first sensor device in communication with the processor, wherein the processor is programmed to receive data from the at least a first sensor device, analyze the received data to assess likelihood that an emergency condition exists and upon determining that likelihood of an emergency condition is greater than a first threshold level, automatically initiating a wireless emergency reporting communication with an emergency dispatcher.

### CROSS-REFERENCE TO RELATED APPLICATIONS

This application claims priority of U.S. Provisional Patent Application Ser. No. 62/699,445 filed Jul. 17, 2018, the disclosure of which is incorporated by reference herein in its entirety for all purposes.

### STATEMENT REGARDING FEDERALLY SPONSORED RESEARCH OR DEVELOPMENT

Not applicable.

### BACKGROUND OF THE DISCLOSURE

Millions of vehicle accidents occur in the United States and throughout the world every year and hundreds of thousands of those accidents result in death or serious injury too accident victims. As in the case of most accidents, when a vehicle accident results in victim injury, one important factor that often affect a victim's short and long term prognosis is emergency personnel (e.g., paramedics, police, fireman, etc.) response time. For instance, if an accident victim is severely injured, a difference of just a few minutes in paramedic response time may literally mean the difference between life and death. Even in the case of non-life threatening injuries, emergency response time can affect the degree of injury sustained, a victim's emotional state and the duration of recovery time required to make a full recovery.

When an accident occurs, because emergency personnel are only rarely on site, notification of emergency personnel to initiate an emergency response is typically left to either accident victims or third party witnesses (e.g., bystanders or passersby). For instance, an accident victim or witness may use her cellular phone device to call 911 or some other emergency number to report accident occurrence, accident location, accident severity, and/or victim circumstances. In response, a human or automated dispatcher assesses emergency response needs and dispatches an optimized response team.

While on scene victim and witness reporting work well in many cases, emergency response initiation which relies on human action has several shortcomings. First, in some cases there may be no victim or witness that is in condition to initiate an emergency response call. To this end some accidents occur in remote locations where no witnesses are present. In some cases a victim may be unconscious, injured or confused so that the victim cannot initiate an emergency call.

Second, in other cases a victim and/or witness may not have a cellular or mobile computing or phone device, the victim's or witness's communication device may not be charged or a victim's communication device may be damaged or may be inaccessible (e.g., the victim may be unaware of the phone device location after an accident occurs). In each of these cases an on scene emergency call would be impossible.

Third, even where a victim and/or witness have access to a workable cellular phone or other communication device, in some cases confusion surrounding an accident may cause people present to assume someone else initiated an emergency response when in fact no one did.

While the problems described above with initiating an emergency call may occur in any vehicular accident, many of the problems are particularly egregious in the case of accidents involving motorcycles. For instance, when a motorcyclist is involved in an accident, bodily injury is often more severe than injury that occurs to victims in an automobile (e.g., a car) so that a motorcyclist is more likely to be unconscious or injured to the point of being unable to locate and manipulate her cellular phone device to issue an emergency call.

As another instance, because of the severity of many motorcycle accidents, a motorcyclist victim is often separated from her phone device during the course of an accident so that the victim is unaware of phone location.

As one other instance, in some cases a motorcycle accident may involve a motorcycle actually leaving the vicinity of a road and impacting some object in some peripheral area so that the accident may not be easily observable to subsequent passersby. For instance, where a motorcycle flies off a road so that an accident terminates down a hill or behind some bushes, occurrence of that accident may not be apparent to a person that travels by that location 10 minutes later in an automobile.

What is needed is an emergency call commencement solution that can initiate an emergency response process automatically when an accident occurs without requiring any intentional victim or witness activity. It would be particularly advantageous to have an automatic emergency response system for use in motorcycle applications. It would also be advantageous to have a retrofittable solution so that riders that have legacy motorcycles can add an emergency response system to an existing motorcycle setup.

### SUMMARY OF THE DISCLOSURE

Consistent with at least some aspects of the present disclosure, in at least some exemplary embodiments, a processor, a transmitter and at least one sensor device may be located on (e.g., integrated into) a motorcycle and, in particular, within a motorcycle headlight assembly, where the sensor device gleans information employed by the processor to recognize that the motorcycle has likely been involved in an accident. The processor is programmed to, upon detecting that an accident likely occurred, automatically transmit a trigger signal initiating some type of emergency response triage process (hereinafter “the emergency triage process”). For instance, in at least some cases the headlight may be for use with some type of portable personal computing device like a cellular smart phone, tablet type computing device or wearable device like a smart watch, smart glasses or goggles, smart helmet, smart badge, smart pendant, etc., where the smart device includes a wireless receiver and a cellular transmitter. Here, when the headlight processor recognizes that an accident likely occurred, the processor may transmit a Bluetooth or other low power near field (NF) or other type of wireless signal to a rider's portable smart device causing the smart device to initiate an emergency call.

In at least some cases where the smart device includes a processor that tracks location, once the emergency call connection is established, the smart device initiates a communication link to an emergency dispatcher and then generates an emergency message that is transmitted to the emergency dispatcher. Hereinafter, unless indicated otherwise, a 911 telephone call or other type of emergency communication or transmission will be referred to as an emergency reporting call. For instance, in at least some cases an emergency communication may indicate at least (1) that an accident occurred and (2) the location of the smart device as a proxy for accident location. In some cases, the emergency communication may also include rider identifying information such as, for instance, name, age, gender, health record information, primary and secondary contact information, the name and contact information of a rider's primary care physician, a phone number or other network address associated with the rider's portable smart device that initiated the emergency call, etc.

In some cases it is contemplated that the headlight sensor or other vehicle mounted sensors may, in addition to generating data that can be used by the headlight processor to ascertain the likelihood that an accident occurred, generate vehicle condition data that may be reported out to a dispatcher as part of an emergency communication. Here, the other vehicle condition data may form at least part of the data used by the processor to assess likelihood that an accident occurred or may be independent of that data. For instance, in the case of a motorcycle, other vehicle condition data may include an indication that the motorcycle is not upright (e.g., is laying on its side), that a front wheel of the motorcycle is missing, that the engine is off, etc. This type of information may be useful to a dispatcher in surmising the likelihood and/or seriousness of a possible accident.

Here, sensors for generating this other information may be located within a motorcycle headlight assembly or may be located at other locations on the vehicle. In addition other sensors that are worn by a cycle rider may be used to generate data useful in surmising likelihood that an accident occurred, rider condition, other accident circumstances, etc.

In at least some cases a cellular or other wireless transceiver may be located within the headlight assembly so that the headlight assembly can operate independent of any other portable computing device to identify and report a likely accident via an emergency reporting call or the like.

In some embodiments after the system initiates an automatic emergency reporting call, a notification may be provided to a rider that the reporting call has been initiated. Similarly, after an emergency reporting call has been successfully completed so that emergency personnel are dispatched to the scene of an accident, a notification may be presented to the rider. Notifications may be provided via text messages on a rider's smart portable computing device or via an on cycle integrated display screen (e.g., instrument panel) or via a portable device on cycle integrated speaker that presents an audible message, audibly via the rider's cellular phone device, etc. In other cases notifications may be presented via a helmet or other wearable device such as, for instance, via a heads up display on a helmet eye cover, via a helmet mounted speaker device, via a smart watch or other wearable device.

In at least some cases after an emergency reporting call is initiated and even after a call is successfully completed, the system may provide a cancellation option to a rider to cancel any unnecessary emergency reporting calls. In some cases cancellation of an emergency reporting call may require a rider to actually have a voice call with a human working as a resource dispatcher to ensure that cancellation is appropriate and desired. In other cases a rider may be required to perform some definitive activity to unambiguously indicate that a call should be cancelled such as, for instance, enter a 6 digit password into the rider's smart computing device to cancel the call.

In some cases an emergency system server may be provided to field calls from riders where the system server is programmed to obtain emergency call information rapidly (e.g., in a fraction of a second or within a few seconds) so that the server can contact an emergency dispatcher and present information in a format suitable for dispatcher consumption even if the initiating on scene processor is damaged or destroyed subsequently for some reason. In some cases an emergency system server may store rider information during a rider registry or commissioning process so that all that is needed during an emergency reporting call is a terse rider ID and simple location information. Then, the system server can access detailed rider information stored by the server, identify an appropriate emergency dispatcher to handle the rider's emergency call and can present rider and accident/emergency information to the emergency dispatcher in a suitable format (e.g., verbally, a digital dump to the dispatcher's workstation computer, etc.).

In at least some cases the headlight including processor and transceiver may be provided as a replacement headlight for replacing an existing original equipment headlight. Here, the replacement headlight would include an external structure that has a shape and size akin to the headlight being replaced where all of the headlight components including the processor and the transceiver are supported within a headlight cavity. Once the replacement headlight is installed it can operate in any of several different ways depending on other devices and sensors that a rider has access to in order to enhance overall system features and functionality.

At least some embodiments include a headlight assembly for use in a vehicle and for reporting emergency conditions to a dispatcher, the headlight assembly comprising a housing forming a cavity, a processor mounted in the cavity, a wireless transceiver supported by the housing and linked to the processor, at least a first sensor device for sensing at least a first condition while the vehicle is operating, the first sensor device in communication with the processor, wherein the processor is programmed to (i) receive data from the at least a first sensor device, (ii) analyze the received data to assess likelihood that an emergency condition exists and (iii) upon determining that likelihood of an emergency condition is greater than a first threshold level, automatically initiating a wireless emergency reporting communication with an emergency dispatcher.

In some cases the first sensor device is at least one of an accelerometer, a gyroscope and a speedometer. In some cases the wireless transceiver is a near field transceiver and wherein the processor initiates a wireless emergency reporting communication by transmitting a near field trigger signal.

In some embodiments the assembly is for use with a user's portable computing device wherein the portable computing device includes a near field transceiver and a second wireless transceiver, the portable computing device receiving the near field trigger signal from the headlight assembly and in response initiating an emergency reporting communication to the emergency dispatcher. In some cases the processor is further programmed to generate a confirmation signal subsequent to transmitting the trigger signal.

Some embodiments further include a rider interface device that generates a confirmation indication in response to the confirmation signal. In some cases the portable computing device includes the interface device. In some cases the confirmation indication is one of an audible signal, a visual signal and a haptic signal. In some cases the confirmation indication includes a cancellation query inquiring if the emergency reporting communication should be cancelled. In some cases the processor continues to collect data from the at least a first sensor device subsequent to automatically initiating the emergency reporting communication.

In some cases the at least a first sensor device includes at least one of a camera and a microphone. In some cases the at least a first sensor device includes a plurality of different types of sensor devices. Some embodiments are for use with at least one rider wearable sensor device, the wearable sensor device generating sensor data that is transmitted to the processor and used by the processor along with the first sensor device data to assess likelihood that emergency conditions occur.

Some embodiments are for use with an integrated computing device that is integrated into the vehicle wherein the integrated computing device includes a near field transceiver and a second wireless transceiver, the integrated computing device receiving the near field trigger signal from the headlight assembly and in response initiating an emergency reporting communication to the emergency dispatcher. In some cases the integrated computing device includes a memory device on which an emergency reporting application is loaded as well as a display screen on which emergency reporting communication status notifications are presented to a rider. In some cases the transceiver is a cellular transceiver, the step of automatically initiating a wireless emergency reporting communication with an emergency dispatcher including initiating a wireless cellular call to the emergency dispatcher via the cellular transceiver. In some cases the portable computing device includes an interface and wherein the portable computing device presents an emergency reporting communication cancellation option to a rider.

In some cases the emergency reporting communication includes at least identity of the rider and location of the vehicle. In some cases the portable computing device determines location of the portable computing device and wherein the emergency reporting communication includes the location of the portable computing device. In some cases the near field transceiver is a Bluetooth transceiver.

Other embodiments include a headlight assembly for use in a vehicle and with a rider's wireless portable computing device, the assembly for reporting vehicle conditions, the headlight assembly comprising a housing forming a cavity, a processor mounted in the cavity, a wireless transceiver supported by the housing and linked to the processor, at least a first sensor device for sensing at least a first condition while the vehicle is operating, the first sensor device in communication with the processor, wherein the processor is programmed to (i) receive data from the at least a first sensor device and (ii) wirelessly transmit the received data to the portable computing device.

In some cases the headlight assembly and the portable computing device of claim 21 wherein the portable computing device includes a second processor that is programmed to analyze the received data to assess likelihood that an emergency condition exists and, upon determining that likelihood of an emergency condition is greater than a first threshold level, automatically initiating a wireless emergency reporting communication with an emergency dispatcher.

Still other embodiments include an emergency reporting system for use in a vehicle and for reporting emergency conditions to a dispatcher, the emergency reporting system comprising (A) a headlight assembly including a housing forming a cavity, a first processor mounted in the cavity, a first near field wireless transceiver supported by the housing and linked to the first processor and at least a first sensor device for sensing at least a first condition while the vehicle is operating, the first sensor device in communication with the first processor, (B) a wireless portable computing device including a second processor, a second near field wireless transceiver linked to the second processor and a third wireless transceiver, the first processor programed to (i) receive data from the at least a first sensor device, (ii)analyze the received data to assess likelihood that an emergency condition exists and (iii) upon determining that likelihood of an emergency condition is greater than a first threshold level, automatically transmit a trigger signal to the second near field transceiver to initiate an emergency reporting communication, the second processor programmed to (i) upon receiving a trigger signal from the first processor, initiate an emergency reporting communication with an emergency dispatcher via the third transceiver.

### BRIEF DESCRIPTION OF THE SEVERAL VIEWS OF THE DRAWINGS

FIG. 1 is a schematic diagram illustrating an exemplary motorcycle and replacement headlight assembly within a larger emergency system that is consistent with at least some aspects of the present disclosure;

FIG. 2 is a flow chart of one process for pairing a smart portable computing device with the FIG. 1 headlight and then assessing accident likelihood and initiating an emergency reporting call that is consistent with at least some aspects of the present disclosure;

FIG. 3 is a flow chart illustrating the FIG. 2 process from the perspective of the a smart portable computing device;

FIG. 4 is a flow chart of a sub-process that may be substituted for a portion of the FIG. 3 process that provides an option to a rider to cancel an emergency call;

FIG. 5 is a perspective view of a smart phone device that may be used with various embodiments of the present disclosure;

FIG. 6 is a perspective partial view of a flat emissive surface type instrument panel on a motorcycle and schematic representation of some panel components and headlight components that is consistent with at least some embodiments of the present disclosure;

FIG. 7 is a schematic similar to FIG. 1, albeit showing a different system embodiment where a headlight assembly includes an integrated cellular transceiver and where an emergency system server is located between a motorcycle and an emergency dispatcher;

FIG. 8 is a top plan view of a headlight assembly that includes some input and output interface components that is consistent with at least some aspects of the present disclosure; and

FIG. 9 is a front plan view of a headlight assembly that includes speakers built into an upper light bezel that is consistent with at least some aspects of the present disclosure;

FIG. 10 is a flow chart illustrating a process that may be performed by the system of FIG. 7 where an emergency system server is located between a motorcycle and an emergency dispatcher; and

FIG. 11 shows the process of FIG. 10 from the perspective of the emergency system server.

### DETAILED DESCRIPTION OF THE DISCLOSURE

The various aspects of the subject disclosure are now described with reference to the drawings, wherein like reference numerals correspond to similar elements throughout the several views. It should be understood, however, that the drawings and detailed description hereafter relating thereto are not intended to limit the claimed subject matter to the particular form disclosed. Rather, the intention is to cover all modifications, equivalents, and alternatives falling within the spirit and scope of the claimed subject matter.

In the following detailed description, reference is made to the accompanying drawings which form a part hereof, and in which is shown by way of illustration, specific embodiments in which the disclosure may be practiced. These embodiments are described in sufficient detail to enable those of ordinary skill in the art to practice the disclosure. It should be understood, however, that the detailed description and the specific examples, while indicating examples of embodiments of the disclosure, are given by way of illustration only and not by way of limitation. From this disclosure, various substitutions, modifications, additions rearrangements, or combinations thereof within the scope of the disclosure may be made and will become apparent to those of ordinary skill in the art.

In accordance with common practice, the various features illustrated in the drawings may not be drawn to scale. The illustrations presented herein are not meant to be actual views of any particular method, device, or system, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or method. In addition, like reference numerals may be used to denote like features throughout the specification and figures.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the disclosure may be implemented on any number of data signals including a single data signal.

The various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and acts are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the disclosure described herein.

In addition, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on a computer-readable medium. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers or processors.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

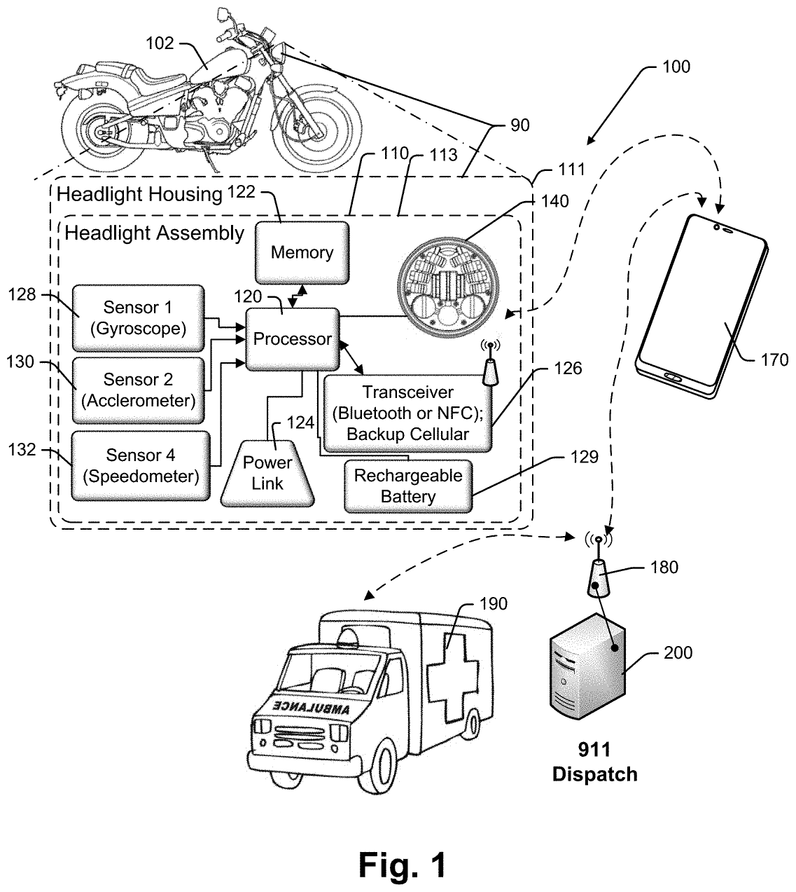

Referring now to FIG. 1, an exemplary system that is consistent with at least some aspects of the present disclosure is shown at 100 in the context of a motorcycle 102 that includes a headlight 90 including an exterior light housing 111 and a headlight assembly 110 where a cycle rider carries a portable smart device 170 while riding the cycle 102. The system 100 includes an emergency system where emergency responders can be dispatched to help the vehicle rider when necessary (e.g., when the rider is involved in an accident or otherwise needs help). Emergency responders are represented by ambulance 190 in FIG. 1 and throughout this disclosure but it should be appreciated that other types of emergency responders are contemplated including police, fireman, doctors, nurses, tow trucks, and other types of medical and service personnel.

An emergency or emergency dispatcher is represented by a wireless transponder system 180 and a server 200 and, in many cases, would also include one or a plurality of human dispatchers to receive and field 911 or other emergency communications where the dispatchers are responsible for assessing user needs and dispatching resources (e.g., police, ambulances, fireman, etc.) to meet those needs. The wireless transponder system 180 may include any combination of wireless communication access points including WIFI points, cellular towers, satellites, etc. The emergency dispatcher may communicate with emergency responders represented by ambulance 190 via cellular or some other type of reliable wireless communication system.

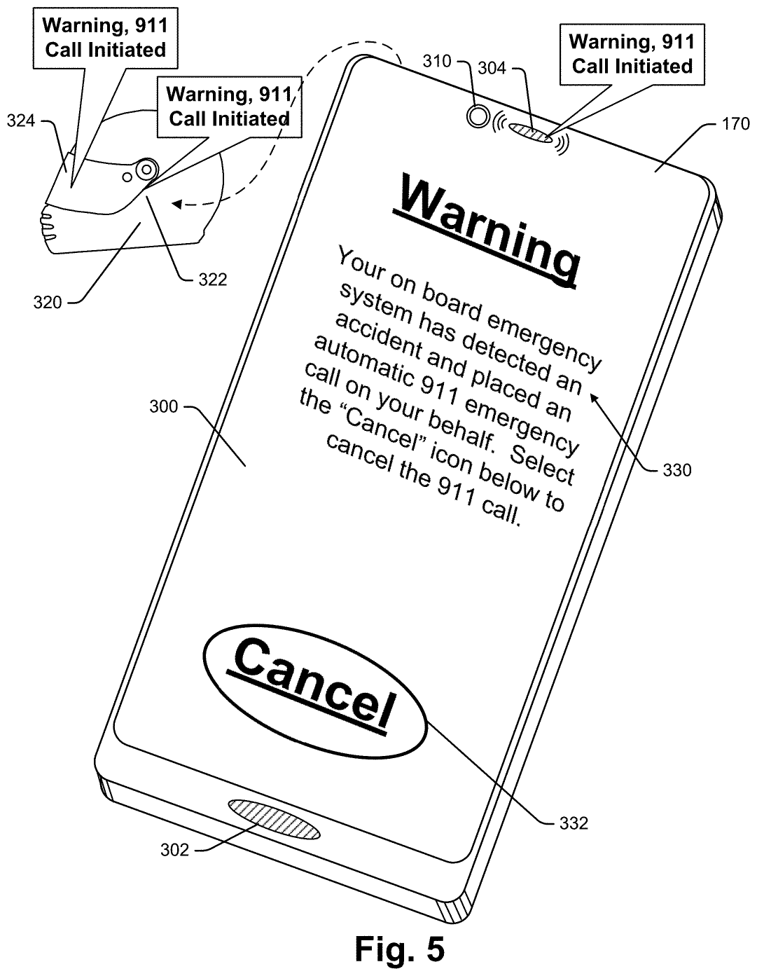

Referring still to FIG. 1, portable smart device 170 is shown to be a wireless smart phone type device that is well known in the electronics and communications industry. In addition to including a processor, a memory, a battery, and a transceiver (not shown), referring to FIG. 5, smart device 170 includes a display screen 300, a microphone 302, one or more speakers 304 and a camera 310.

As well known in the smart device industry, various types of software applications can be downloaded to the smart device memory and run by the smart device processor to perform various tasks for the device user. Consistent with at least some aspects and embodiments of the present disclosure, an emergency reporting application may be downloaded to the smart device memory and used in conjunction with the inventive system to provide an emergency reporting service for a cycle rider. Any subset of several different tasks may be performed by the smart device processor running the emergency application, several of which are described hereafter. In at least some embodiments, at least one smart device application enables the smart device processor to ascertain device 170 location using, for instance, any of several different GPS triangulation methods that are well known in the positioning system arts. Other technologies for determining smart device location are contemplated. In at least some cases the smart phone processor may be able to determine device 170 location to within a few feet (e.g., 3) of the actual location of device 170 in space.

The smart device display screen 302 is a touch sensitive screen so that a user can touch the screen to provide various types of input to applications run by the smart device processor. To this end, the smart device processor may present touch selectable icons via screen 302 as well as output text and/or graphics to receive user input and provide application output to the user, respectively. The smart device transceiver, display screen 302, microphone 304 and speaker(s) 310 are linked to the smart device processor for receiving input from a user and providing application output to the user. The smart device processor is capable of communicating via the smart device transceiver using several different wireless communication protocols in at least some embodiments including Bluetooth as well as other near field communication (NFC) protocols and cellular protocols. For instance, in FIG. 1, the smart phone device 170 may communicate with a transceiver 126 that forms part of the headlight assembly 110 via Bluetooth and may communicate via a cellular communication protocol with the wireless transponder system 180.

While device 170 is shown as a smart phone type device that is typically held in a user's hand, other types of portable smart devices are contemplated that could be used within system 100 instead of a phone type device. For instance, in at least some cases device 170 may be replaced by a smart watch device that includes similar components and capabilities. Other smart devices that may be swapped in for device 170 include smart eyewear, a smart ring, a smart badge, a smart pendant, a helmet, a smart boot, or any other type of smart device.

In at least some cases it is contemplated that the best smart device for a motorcycle application is one which a rider regularly wears such as, for instance, a smart watch worn on a user's wrist which a rider is less likely to leave at home or at some other location while riding. Even better is a smart device that is built into a wearable riding safety device such as, for instance, a motorcycle helmet, a boot, etc. Unless indicated otherwise it should be appreciated that any time device 170 is referenced, any type of smart device with similar capabilities and functions may be swapped in for device 170 to provide similar or identical functionality unless indicated otherwise.

Referring still to FIG. 1, headlight assembly 110 includes a headlight that is mounted in a housing 111. Exemplary headlight assembly 110 includes, a headlight housing 113, a headlight processor 120, a memory 122, a power link 124, the transceiver 126, first, second and third sensor devices 128, 130 and 132, respectively, and a light generating assembly 140 that includes light sources like LED engines, incandescent bulbs, etc., as well as reflectors and optics arranged to generate one or more light patterns in front of motorcycle 102 during operation. The processor 120, sensors 128, 130, 132 and transceiver 140 are all located within the headlight housing 113.

Housing 111 is often finished on an exterior to provide an aesthetically finished look consistent with motorcycle styling. Housing 111 typically forms a headlight assembly receiving cavity which is designed to receive assembly 110. While not shown, housing 111 also typically includes some type of releasable mechanical fastener which can be manipulated to lock and unlock the headlight assembly 110 within the cavity formed by housing 111.

Processor 120 is linked to power link 124 to receive power therefrom and link 124, in most cases, will be linked to a motorcycle battery (not illustrated) or power conditioning circuitry. Processor 120 may run programs to perform many functions normally associated with a headlight processor. For instance, processor 120 may control high and low beam light functions, turning light patterns that change as a user banks motorcycle 102 through left or right turns, as well as other headlight functions. Each of the sensors 128, 130 and 132, memory 122, light generating assembly 140 and transceiver 126 are linked to processor 120.

In addition to other software, an emergency software program is loaded into memory 122 and is run by processor 120 to provide an emergency reporting function that is consistent with at least some aspects of the present disclosure. In general, the emergency function ascertains when it is likely that motorcycle 102 has been in an accident and automatically initiates a 911 or other emergency communication with the intent that emergency responders be dispatched to the most recent location of phone device 170.

The method or process used by processor 120 to initiate an emergency communication may take many different forms based on many different sensed motorcycle states and operating parameters as well as combinations thereof. The states and parameters that are used to assess likelihood of an accident may be simple or very complex. For instance, in at least some simple cases processor 120 will be programmed to determine that an accident is likely whenever motorcycle 102 is laid on its side. As a more complex instance, in other cases processor 120 will require that the cycle is laid on its side as well as an abrupt stop or other violent motion that is consistent with an unexpected vehicle crash. Many other accident discerning algorithms are contemplated.

Referring still to FIG. 1, exemplary sensors in head light assembly 110 include a gyroscope 128, an accelerometer 130 and a speedometer 132. Here, gyroscope 128 and accelerometer 130 may present signals to processor 120 useable to determine when motorcycle 102 is laid on its side as well as for detecting when the cycle has abruptly slowed down or made some unexpected and unnatural movement (e.g., flipped over, rolled, etc.). Speedometer 132 may present speed signals to processor 120 usable to determine an instantaneous motorcycle speed.

In embodiments like the one illustrated in FIG. 1, in at least some cases the headlight assembly will be provided as original equipment with a motorcycle when the cycle is purchased. In other cases the headlight assembly 110 will be provided as a replacement light assembly for an existing motorcycle headlight. One advantage to the replacement bulb assemblies is that all of the sensors and electronics as well as the transponder required to facilitate an emergency reporting process may be provided in the replacement headlight assembly where the only hardwire links to the replacement headlight include existing power links provided for a light device that is being replaced. Thus, referring still to FIG. 1, again, each of processor 120, sensors 128, 130 and 132, memory 122 and transceiver 126 are located within the headlight housing 113 which can be designed to have the same general shape and size as the light assembly that it replaces. In other words, a user that purchases a replacement light assembly 110 consistent with FIG. 1 would simply remove an existing light assembly from exterior finished housing 111 and replace it with light assembly 110 shown in FIG. 1, using an original equipment electrical connector to provide power to assembly 110.

Once assembly 110 is installed, the vehicle user may use her smart phone device 170 to download an emergency reporting application as described above. In at least some cases this process may be facilitated by the headlight assembly processor 120. To this end, with processor 120 powered and a rider having his phone 170 on and in the vicinity of assembly 110, assembly 110 may broadcast a Bluetooth or other wireless ID signal which is picked up by device 170 and indicated as a device for wireless pairing with phone device 170 via display screen 300. The rider may select assembly 110 for pairing with device 170 which may cause processor 120 to transmit an internet link to phone device 170 useable to download the emergency reporting application from a remote server. Once the emergency reporting application is downloaded onto phone device 170, that application is stored for subsequent use. Once the application is stored, any time device 170 is on and cycle 102 is started, device 170 and processor 120 may automatically perform a wireless paring process as well known in the communication arts. For instance, the pairing process may include one of processor 120 or the smart device processor pinging the other of the processors any time it is powered after which, when both processors are on, a handshaking protocol results in the pairing automatically without requiring additional user action.

Referring yet again to FIG. 1, the emergency reporting application is programmed with one or more emergency calling numbers or other communication addresses (e.g., network addresses) so that smart phone device 170 can call or otherwise link wirelessly to the emergency dispatcher 180/200 when necessary.

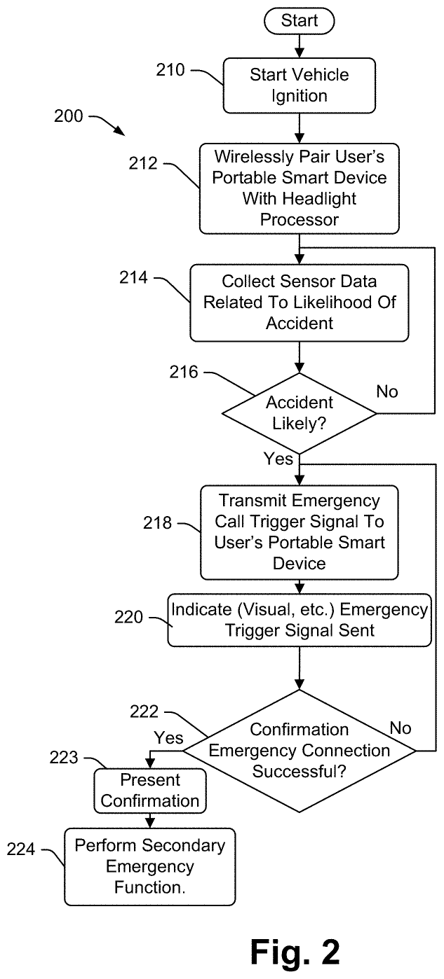

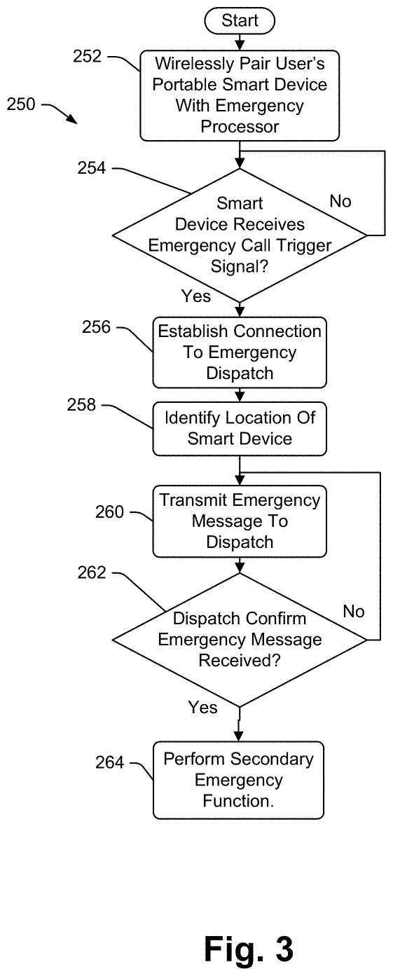

Referring now to FIG. 2, a process 200 that may be performed by headlight processor 120 in FIG. 1 is illustrated where the process is for pairing a rider's smart device with the headlight processor 120, for detecting a likely emergency situation and for initiating an automatic emergency reporting call. In addition, FIG. 3 shows a process 250 that may be performed by smart phone device 170 in FIG. 1 in parallel with the FIG. 2 process. The FIG. 2 and FIG. 3 processes as well as other processes described hereafter occur after the initial wireless pairing of the user's phone device 170 and headlight processor 120 and emergency reporting application download and storage as described above.

Referring to FIGS. 1 and 2, at block 210, the cycle rider starts up motorcycle 102. At block 212, with phone device 170 on and in near proximity to processor 120, the smart phone processor and headlight processor wirelessly pair so that a wireless communication link is established. Block 252 in FIG. 3 shows the wireless pairing step related to the smart device 170. At block 214, while motorcycle 102 is powered on and for at least some threshold period thereafter (e.g., 2 minutes), headlight processor 120 continually or repeatedly collects sensor data related to likelihood that motorcycle 102 has been in a recent accident. For instance, again, processor 120 may use sensor data from sensors 128, 130 and 132 to detect when cycle 102 is on its side and when cycle 102 has rapidly come to a complete stop, the combination of those circumstances being a tell tail sign that an accident likely occurred. In addition, processor 120 may continue to monitor cycle orientation and movement so that if the cycle is manipulated to stand upright and the cycle starts to move (e.g., cycle speed accelerates to some threshold level), the determination that an accident likely occurred can be automatically cancelled or at least an option to cancel the determination may be presented to the rider.

In cases where processor 120 continues to collect data for a period subsequent to a motorcycle being turned off, the idea is that cycle condition data subsequent to turning off a motorcycle may be useful in determining that an accident occurred. In cases where an accident likely occurred, processor 120 may be programmed to persistently collect cycle and scene data for a longer duration (e.g., instead of 2 minutes, for an extended 30 minute period). Similarly, in cases where an accident likely occurred, processor 120 may be programmed to collect a different subset of data than the set collected prior to the determination that an accident likely occurred. Any data subset of conclusions calculated or discerned by processor 120 about scene conditions may be continually or at least periodically transmitted by the rider's smart phone device to a dispatcher or even directly to emergency personnel during post-accident event periods.

Referring again to FIGS. 1 and 2, if an accident is unlikely at block 216, control passes back up to block 214 where monitoring for accident conditions or circumstances continues to loop. If an accident did likely occur at block 216, control passes to block 218 where processor 120 transmits an emergency call trigger signal to the user's portable smart phone device 170 to initiate an emergency reporting call to emergency dispatcher 180/200.

Referring again to FIG. 3, smart device 170 receives the call trigger signal at block 254 where, once a trigger signal is received, control passes to block 256. At block 256, smart device 170 establishes a communication link or connection to the 911 emergency dispatcher 180/200 and then identifies its current location at block 258. At block 260, smart device 170 transmits an emergency message to dispatcher 180/200 that indicates, at a minimum, the identity of the cycle user and the most recent location of smart device 170 so that emergency responders know where to go to locate the accident.

Referring still to FIG. 3, at block 262 the dispatcher 180/200 transmits a confirmation back to smart phone 170 once the emergency message is received after which the smart phone device 170 may performs some other secondary emergency function (see block 264). In at least some cases the secondary emergency function may include presenting a message to the cycle user via portable device display screen 300 and/or the device speaker 304 (e.g., automatically enable a speaker phone option on device 170, maximize device 170 volume, and broadcast a message) indicating that the emergency communication was successful. In some cases the secondary function may include transmitting a digital SOS signal to proximate passersby requesting help or assistance, staying linked to the dispatcher to update the dispatcher with other important information about the likely accident and/or to cancel any emergency call that is determined to be in error based on other sensed parameters.

One other secondary emergency function may be to initiate a voice call with the emergency dispatcher 180/200 and to enable a speaker phone function on device 170 so that a rider has an immediate voice communication line to the dispatcher. Here, if a rider is conscious after an accident occurs, the rider may be able to verbally communicate with the dispatcher and provide important condition and accident information, confirm the need for specific responder capabilities, etc. This feature may be particularly valuable in cases where the smart device is built right into a rider's helmet so that smart device microphone and speaker affordances are positioned optimally for voice communications with a dispatcher. In some cases the smart phone device may also pair with a rider's helmet that includes a Bluetooth linking option so that voice communications with dispatch are transferred back and forth between the rider's helmet and dispatch through the rider's phone device 170. Helmets that communicate with a rider's smart device via wireless or in some cases wired communication are well known in the safety arts.

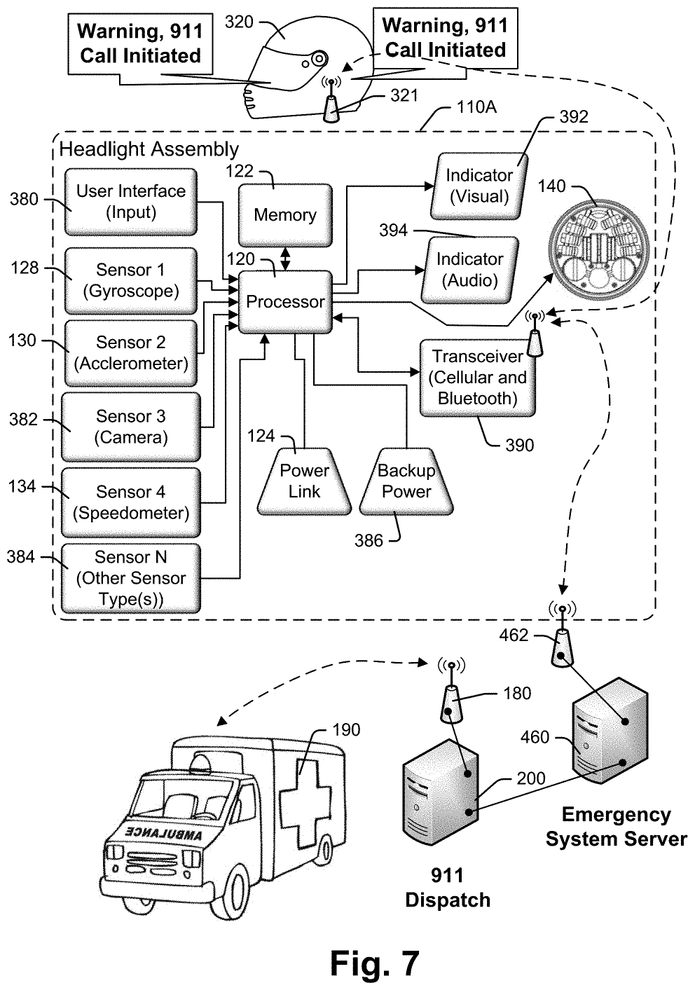

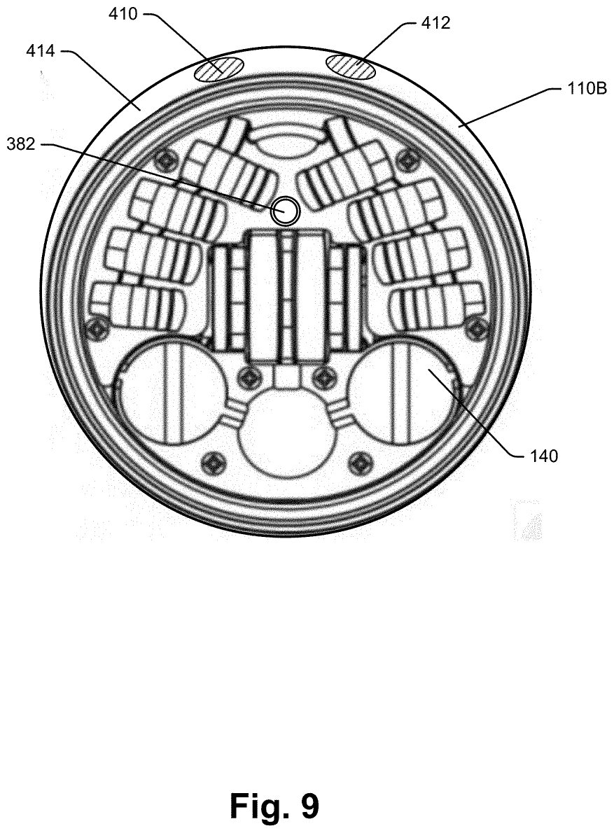

Another secondary emergency function may be to initiate a video call with the emergency dispatcher 180/200 whenever an accident is likely. Here, in addition to determining accident circumstances, the video may be useful in determining whether or not an accident occurred. In this regard, the video communication may use a smart device 170 camera or some other camera on the scene of an accident. For instance, see in FIG. 9 that an exemplary headlight assembly is shown including a digital camera 382 that operates as a sensor input to a headlight processor (see also FIG. 7). In some cases once an accident occurs, video or at least images from camera 382 may be transmitted to a dispatcher as part of an initial data dump or subsequent thereto as an indicator of scene circumstances.

In other cases, the secondary emergency function may include transmitting a Bluetooth or other wireless signal to headlight processor 120 indicating a successful emergency communication.

In at least some cases it is contemplated that headlight processor 120 may perform some process to provide emergency reporting feedback to the cycle rider. For instance, when an emergency trigger signal is initially transmitted to the user's portable device 170, processor 120 may automatically control light devices in assembly 140 in a unique fashion that should be perceivable by the cycle user but that is distinguished from other “normal” headlight effects. For instance, processor 120 may flicker light devices in assembly 140 on and off rapidly upon detecting a likely accident and transmitting a trigger signal to smart device 170 and may pulse on and off once an emergency reporting to a dispatcher is confirmed. In some cases the pulsing may form a pattern such as, for instance, an “SOS” Morse pattern to indicate a successful emergency call. To this end, see again FIG. 2 where, after transmitting the call trigger at 218, control passes to block 220 where a visual (e.g., flickering light) “sent” signal is generated.

At block 222 the headlight processor 120 monitors for a confirmation signal back from the dispatcher 180/200 and control loops back up to block 218 until such a signal is received. Once a confirmation signal is received, control passes to block 223 where processor 120 presents a confirmation signal to the user after which control passes to a secondary emergency function. Many different secondary functions 224 are contemplated as described above.

Processor 120 continues to gather sensor information from sensor devices 128, 130 and 132 even after cycle 102 is powered off. In many cases when an accident occurs, a vehicle may be completely turned off or powered down. Here, if the cycle is powered down because of an accident and prior to a successful emergency communication being transmitted, the system would not operate properly and an accident may not be reported. In some cases the duration of time processor 120 remains functional may be 30 or more seconds and in other cases processor 120 may remain powered for 2, 3 or more minutes after the cycle is powered down. To ensure that processor 120 can transmit an emergency initiating signal after an accident occurs, in at least some embodiments a rechargeable battery 129 may be provided as part of assembly 110 to power the assembly even if power via link 124 is disconnected for some reason. In some cases the battery 129 may also be used to power a backup cellular transceiver (see 126) to be used automatically when a smart phone device 170 or other smart device is not available (e.g., not present, off, insufficient battery power) for handling 911 or other call types.

In at least some cases, instead of detecting data that can be used to discern likelihood of an accident immediately upon vehicle ignition and until sometime after the vehicle is powered down, processor 120 may only capture data related to accident likelihood once a vehicle starts to move and for some duration thereafter (e.g., 20 seconds) or may only capture data once the cycle has increased speed to a level above some threshold speed (e.g., 10 MPH). Similarly, where processor 120 is capable of performing two or more different processes for ascertaining likelihood of an accident, it may be that the processor uses first and second different accident detecting algorithms under different circumstances (e.g., the first when cycle speed is below 10 MPH and the second when cycle speed is above 10 MPH) or even uses three or more different algorithms under different circumstances.

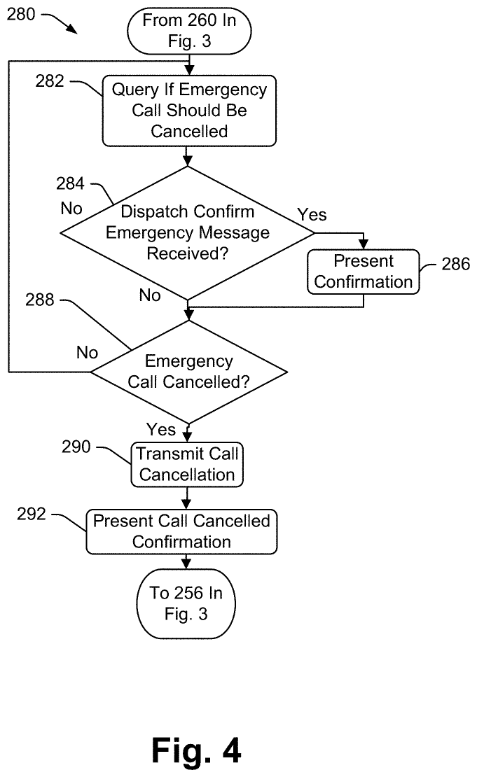

It has been recognized that there may be instances where processor 120 erroneously detects a likely accident or where a cycle user does not want to report a non-serious accident (e.g., a slow laydown of the user's bike where the user was not injured) detected by the headlight processor 120 for some reason. For these reasons, in at least some embodiments it is contemplated that the system may be designed to provide a user with the ability to cancel an emergency reporting call when desired. To this end, a sub-process 280 that may be substituted for a portion of the process shown in FIG. 3 is illustrated in FIG. 4. Referring again to FIG. 3, after block 260, control may pass to block 282 in FIG. 4 where a rider's smart device 170 (see again FIG. 1) queries the rider as to whether or not the emergency call should be cancelled.

Referring also to FIG. 5, portable device 170 is shown with an exemplary warning and query offering the rider an option to cancel the emergency call. To this end, the exemplary warning includes text as shown at 330 indicating what is happening and a virtual “Cancel” icon 332 that is selectable to cancel the emergency call. In addition to the visual query on display screen 300, device 170 may also be programmed to present an audible warning or query via device speaker 304 and may also be programmed to listen for a cancellation utterance from the user picked up via microphone 302.

While a simple “Cancel” icon is shown in FIG. 5 for cancelling an emergency reporting call, in other cases a rider may have to enter a six digit code via a virtual keyboard or the like to cancel an emergency reporting call. To this end, one thing to be avoided is an inadvertent cancellation of an emergency call through unintended selection of a simple cancel option. In other cases a rider may have to call an emergency dispatcher in order to verbally cancel an emergency reporting call.

Referring still to FIG. 5, where the cycle user has a “smart” helmet that can be wirelessly or otherwise (e.g., a cable) linked to the user's portable device 170, speakers 322, a microphone (not illustrated) and even a heads up display 324 may be used to present warnings and queries to the user. A smart helmet is a particularly good interface for emergency use as that system component should remain intact on a user even if the user sustains injuries. For instance, where a helmet audibly queries a user if she wants to cancel a 911 emergency call, the user may be able to verbally respond “Yes, cancel the call” to indicate that the call should be cancelled. In other cases, the system may enable the user to provide verbal information characterizing her injuries or other information that may be useful by emergency responders that can be presented in an emergency communication to a dispatching station.

While the system may request confirmation to initiate or continue an emergency call, confirmation of such calls is dangerous as an accident victim may not be able to confirm a call either because of injury or proximity to an input confirmation device or tool. Instead, in optimal systems, emergency calls may always proceed absent some clear user indication that a call should be terminated. By erroring on the side of making and continuing a call as opposed to not, the system is rendered more effective overall.

Referring again to FIG. 4, at block 284 device 170 determines if dispatch received the emergency message and if the message was received, a confirmation is presented to the user via device 170 at block 286. If the message has yet to be received control passes to block 288.

At block 288, device 170 determines if the emergency call has been cancelled and if not, control loops back up to block 282 where the process continues to cycle. At block 288, if the rider initiated a call cancellation, control passes to block 290 where device 170 transmits a call cancellation to the emergency dispatcher to halt the emergency reporting call and then at block 292 a call cancellation confirmation message is presented to the cycle user via device 170.

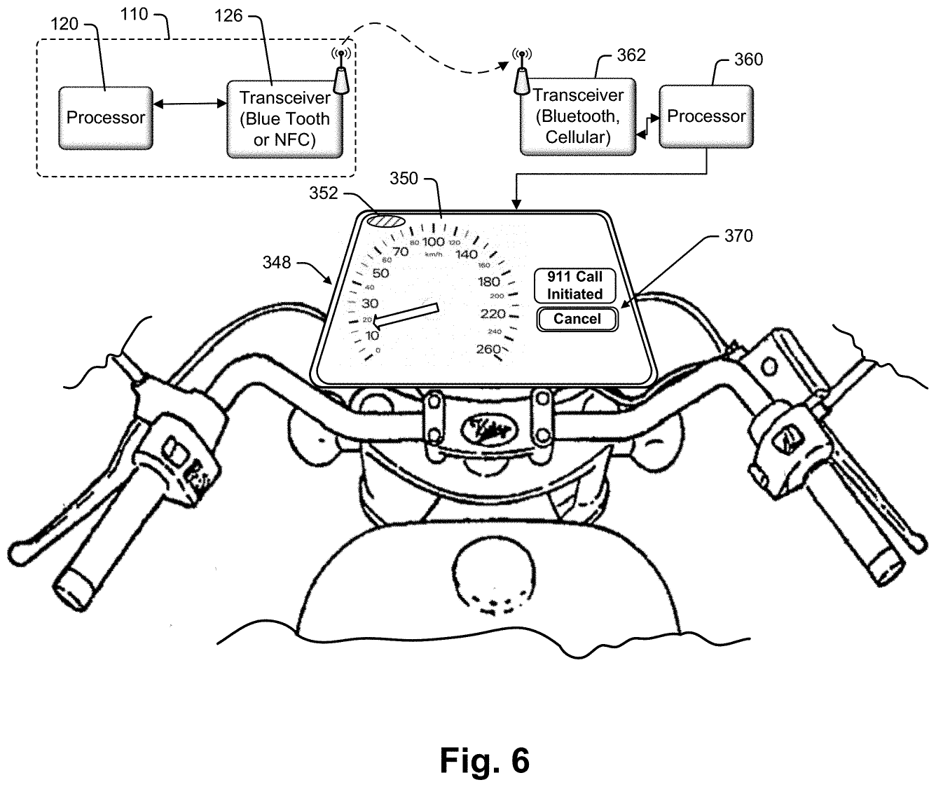

In at least some cases vehicles and more specifically motorcycles now come equipped with integrated computing devices that include display screens, an on board processor and a Bluetooth or other wireless transceiver akin to the components in a portable smart device so that the functionality of the portable device 170 described above can be provided by on cycle assemblies. To this end see, for instance, FIG. 6 that shows an integrated computing device 348 including a display screen 350 for presenting a graphical interface including cycle operating data like a speedometer as well as other output and input features. An on-cycle processor and transceiver that form part of the integrating computing device 348 are shown schematically at 360 and 362, respectively, where processor 360 links to the transceiver and the display screen 350. Here, the headlight processor 120 and transceiver 126 communicate with the on-cycle transceiver 362 and processor 360 in a manner similar to that described above in the context of processor 120 and portable device 170 and may perform any of the processes or functions described above.

While shown as a wireless communication link, in cases where an onboard processor 360 performs various computing and call transmission functions for a headlight assembly 110, the link between headlight 110 and processor 360 may be wired. In this regard, it is contemplated that in at least some cases a screen 350 that includes a processor 360 that can run various application programs may include standard connection ports (e.g., USB, USB-C, etc.) for connection to other motorcycle equipment. In some cases a headlight assembly 110 may be equipped with a cable port so that a user has the option to link the assembly 110 via a USB or other cable type directly to the display processor 360.

Referring still to FIG. 6, a set of virtual buttons and indicators are shown at 370 that may be presented to a cycle user when a 911 emergency reporting call is initiated and to give the user an opportunity to cancel the emergency call if desired. The indicators include a “9 11 Call Initiated” icon that is presented once processor 360 initiates an emergency call and the button includes a virtual “Cancel” button that can be used to cancel the call. Again, a virtual keyboard may be presented instead of the cancel button so that a rider can enter a cancellation code for an initiated call. Once a emergency reporting call is confirmed, the “911 Call Initiated” icon may be replaced by a “911 Call Confirmed” icon (not illustrated) to indicate the changed status of the emergency call. The assembly in FIG. 6 also includes a speaker 352 so that an emergency reporting call announcement may be audibly generated. While not shown, the FIG. 6 assembly may also include a microphone for receiving verbal commands from the cycle user to initiate, confirm or cancel an emergency call. Again, processor 360 may also link to other rider worn devices like a helmet 320 (see FIG. 5), a smart watch, etc., for providing warnings and notifications to a rider and to receive input or feedback from a rider when desired.

While an originally equipped motorcycle may include a headlight akin to the light described and illustrated in FIG. 1 and a virtual instrument panel as shown in FIG. 6, in other cases it is contemplated that an originally equipped motorcycle may only include the virtual instrument panel with Bluetooth or other communicating capabilities. Here, as in the case of smart phone 170, it is contemplated that other applications may be downloaded into a memory associated with panel processor 360 including an emergency reporting application which can initiate emergency reporting calls as well as present panel or interface reporting and warning tools as shown in FIG. 6. In these cases, as described above, a rider may purchase a replacement headlight as shown in FIG. 1 to replace an original equipment headlight where the replacement device includes the accident detecting and reporting affordances described above. Here, as in the case of the smart phone 170 described above, the headlight assembly may be paired with processor 360, a supporting emergency reporting application may be downloaded to and stored by processor 360 and then processor 360 and the replacement headlight assembly may operate in a fashion similar to that described above with respect to phone device 170 and headlight assembly 110.

One advantage to running the reporting application on processor 360 is that assembly 350 is integrated into the motorcycle and therefore cannot be forgotten or misplaced by a rider. Another advantage to providing reporting via the integrated assembly 350 is that the system leverages off other motorcycle devices that are already provided for other purposes so that a rider does not have to have his own personal portable computing device (e.g., phone 10) to use the system.

In at least some cases it is contemplated that a cellular transceiver may be built directly into a headlight assembly for transmitting 911 emergency calls to a dispatcher 180/200 so that there is no need for an on-cycle processor like processor 360 in FIG. 6 or for a cycle user to also carry a separate portable smart device 170. To this end, see the exemplary headlight assembly 110A shown in FIG. 7 where components similar to components already described above with respect to FIG. 1 are similarly labelled and operate similarly unless indicated otherwise. One difference between assembly 110A and assembly 110 is that assembly 110A includes a cellular transceiver 390 as opposed to a Bluetooth or near field transceiver so that processor 120 can call a dispatcher 180/200 directly without having to call out through a rider's smart device 170 or an integrated processor 360. Here, processor 120 may also be programmed to determine processor location via cellular signals received via transceiver 390 so that motorcycle location can be indicated as part of any emergency reporting call.

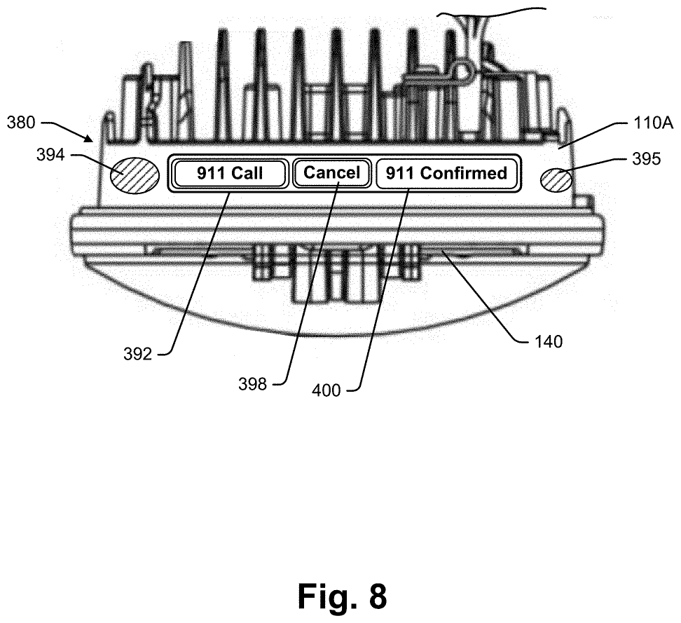

One other difference between assemblies 110A and 110 is that headlight assembly 110A includes an integrated user interface 380. Referring also to FIG. 8, an exemplary interface 380 is illustrated that includes a “emergency reporting call” button 392, a “Cancel” button 398, an output indicator light 400 an audio speaker 394 and a microphone 395. The output indicator light 400 lights up after an emergency reporting call has been successfully completed so that emergency personnel are on their way to help a rider. “Cancel” button 398 is selectable to cancel an initiated emergency reporting call. Button 392 allows a user to initiate an emergency reporting call for any reason and may be selected irrespective of whether or not a likely accident has been detected.

Speakers 394 are controlled to generate alarms or warnings related to the emergency reporting system. For instance, a warning “emergency reporting call initiated” may be broadcast via speakers once an emergency reporting call is initiated followed by other warnings and alerts. One advantage associated with audible warnings is that a rider can detect the warnings irrespective of where the user is looking. Thus, for instance, if a rider is down and cannot turn his head to look at the headlight assembly 110A, the audible annunciation that an emergency reporting call has been initiated and a confirmation that the emergency reporting call has been successful and that emergency personnel are on their way can give peace of mind to an injured rider. Microphone 395 can be used to receive input from a rider. For instance, in cases where there is no touch type tactile interface for cancelling a reporting call, processor 120 may broadcast a verbal call cancellation option and then wait for a verbal response picked up by microphone 395 to cancel the call.

FIG. 9 shows another exemplary headlight assembly 110B that includes an interface, albeit where the interface includes only a speaker 410 and a microphone 412 that are integrated into an enlarged upper portion of a light assembly bezel 414. Here, while the speaker and microphone are directed forward, again, because sound travels in all directions, those devices can be used to communicate with a proximate rider irrespective of rider location and eye trajectory. By building the speaker and microphone into the front facing portion of the headlight there is no need to modify an originally equipped headlight housing to accommodate the interface affordances.

Referring again to FIG. 7, where the transceiver 390 is located in the headlight assembly itself, that transceiver may be programmed to communicate emergency reporting call messages to a rider via Bluetooth or other near field communication protocols and via other interface devices like, for instance, a heads up display in the rider's helmet, a speaker in the riders helmet 320, etc. In other cases where a motorcycle includes a virtual interface as in FIG. 6, the headlight assembly transceiver may transmit messages to the rider via the display screen 350.

Referring again to FIG. 7, headlight assembly 110A includes other sensors including a camera 382 and other sensors generally represented by numeral 384. See also exemplary camera 382 in assembly 110B in FIG. 9. Camera 382 may be provided for various purposes including but not limited to collecting information useable by processor 120 to assess likelihood that an accident occurred, to collect information about circumstances leading up to an accident and circumstances that exist at a location after an accident likely occurred, etc. In some cases when an emergency reporting call is initiated, processor 120 may transmit camera video to a dispatcher corresponding to a period (e.g., 20 seconds) prior to the start time of the accident as well as video data subsequent to the accident so that a dispatcher can assess accident likelihood and severity and other circumstances that may warrant dispatch of specific resources. Similarly, processor 120 may transmit a recorded and/or continually recording audio clip to a dispatcher for consideration. In addition, processor 120 may transmit other data used to assess likelihood of an accident or conclusions about likelihood of an accident to a dispatcher for consideration. In embodiments where a smart phone 170 or other smart device outside the headlight assembly transmit emergency reporting calls to a dispatcher any of the information collected by any of the sensor devices including audio, video, raw data and/or conclusions may be transmitted by the smart device for dispatcher consideration.

Smart portable computing devices like smart phone 170 are being equipped with more and more affordances such as accelerometers, gyroscopes, etc. Similarly, motorcycles sometimes are equipped with sensors for other than accident determining purposes where the sensors generate data that is useful in assessing accident likelihood. For instance, most motorcycles include speedometers. In at least some cases it is contemplated that data usable to assess likelihood of an accident may be received by a headlight processor from other paired or wirelessly linked devices when available. Thus, an emergency reporting application run on a smart phone may track gyroscope and other sensor data and provide that data to the headlight processor 120 for accident assessment processing. Similarly, speedometer data generated by a motorcycle speedometer may be transmitted to the headlight processor 120 from a Bluetooth transceiver integrated into a motorcycle so that processor 120 can use that data to assess accident likelihood.

In at least some embodiments it is contemplated that a headlight may be paired with several different smart devices so that any one of those devices can thereafter be used to facilitate an emergency reporting scheme per the above description. In some embodiments it is contemplated that a headlight may not operate without a paired and operational smart device being present to encourage that the emergency reporting function be enabled prior to riding. In the alternative there may be some way to override the requirement to have a portable computing device enabled and paired while riding which includes some intentional sequence of activities to ensure that a rider is keenly aware that her emergency reporting function is not enabled.

It has been recognized that after an initial accident occurs, accident conditions and circumstances can deteriorate rapidly in many cases. For instance, a processor or transceiver that attempts to initiate an emergency reporting call that survives an accident may become damaged (e.g., crushed, burnt, water damaged, etc.) shortly thereafter so that the device cannot retransmit a reporting call in the event that the initial call is unsuccessful or is cut off for some reason. It has also been recognized that many dispatchers 180/200 rely on human beings to triage incoming calls where accident related information can only be consumed in an orderly fashion requiring some time (e.g., a minute or more to obtain at least basic accident information). Where a device initiating an emergency reporting call is damaged prior to a human dispatcher obtaining accident information, resource dispatch may be ineffective.

For this reason, in at least some embodiments, it is contemplated that a separate emergency system server may be provided between the device which initiates an emergency reporting call and an emergency dispatcher that can collect rapid transmission of accident information related to a call, store that information, and then transmit that information at a speed and in a format appropriate for a human dispatcher to consume. Here, once triggered by an on scene processor, the emergency system server can initiate emergency reporting calls until one is successful and can continue an emergency reporting call even if the on scene device (e.g., a smart phone, a headlight assembly processor, etc.) becomes damaged for some reason.

It is contemplated that an initial emergency transmission to the system server may include rider identity, accident location, time at which the accident occurred, video and audio related to the accident occurrence, raw data related to the likelihood that an accident occurred and conclusions related to the accident occurrence. In most cases this type of information may be transmitted to a server in less than one second or within a few seconds to start an emergency reporting call process. An initial emergency transmission may be repeated in rapid succession several times or until the emergency system server sends a confirmation message back to the initiating device assuming the initiating device remains functional. FIG. 7 shows an emergency system server 460 located between transceiver 390 located in a headlight and the emergency dispatcher server 200. A wireless transceiver 462 is linked to server 460 for communicating with transceiver 390 and server 460 is linked to dispatcher server 200 which in turn communicates with emergency personnel in its dispatching function.

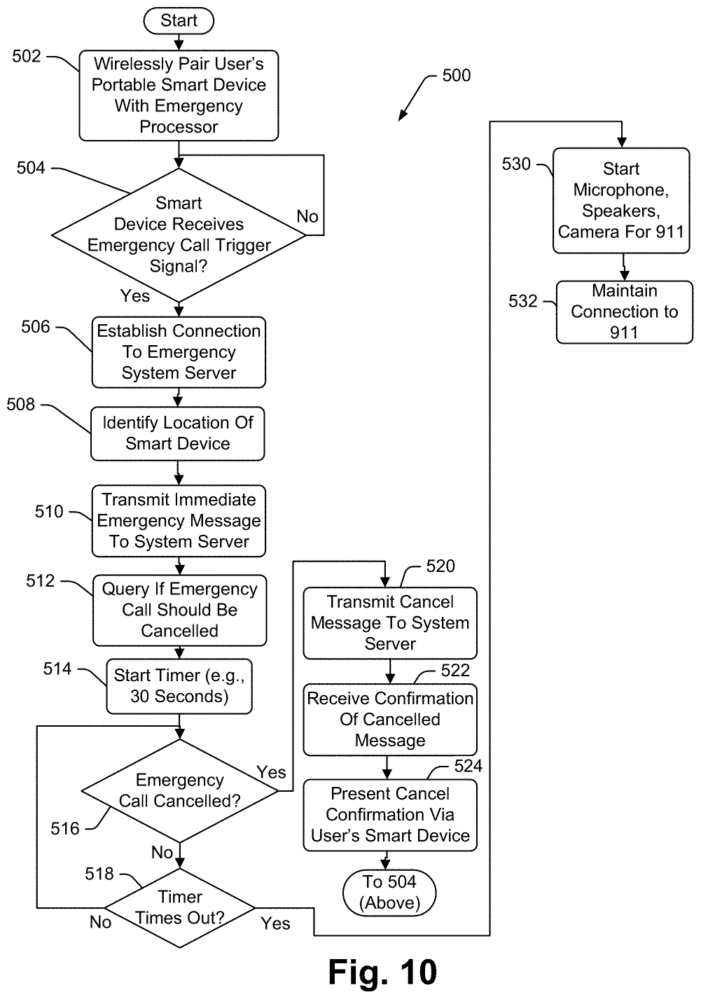

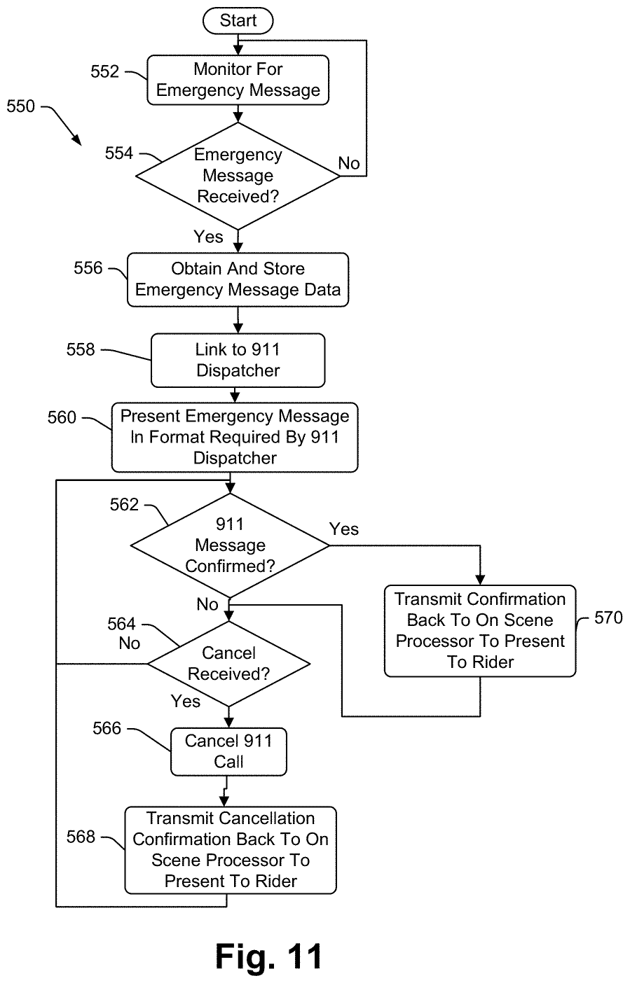

Referring now to FIGS. 10 and 11, processes 500 and 550 that may be performed by an on scene processor and an emergency system server 460 (see again FIG. 7) are illustrated that are consistent with at least some aspects of the present disclosure. In this embodiment it will be assumed that a smart phone 170 is on scene and that the phone processor performs the FIG. 10 operations. At block 502 the phone processor pairs with the headlight processor 120. At block 504, the smart phone monitors for an emergency call trigger signal from the headlight processor 120. Once an emergency trigger signal is received control passes to block 506 where smart phone 170 initiates an immediate call to the emergency system server 460. At block 508 phone 170 determines the location of the phone device 170 and at block 510 the phone 170 transmits an immediate emergency message to server 460 including all data collected or calculated that relates to the possible accident. At this point the emergency call has been initiated and can be handled by the emergency server 460 irrespective of subsequent condition of the on scene portable phone device 170. At block 512 smart phone 170 or some other interface is used to query the rider if the emergency call should be cancelled and a timer is started at block 514. At block 516 the phone device 170 monitors for a call cancelation from the rider.

In FIG. 11, at block 552 the emergency system server 460 monitors for an emergency call from any supported smart device or other supported on scene processors. Once a call is received at block 554, control passes to block 556 where any received message including all accident related data is obtained and stored in a server database where it cannot be destroyed by on scene circumstances. At block 558 the server 460 links to an emergency dispatcher and at 560 the data from the emergency message is formatted in a manner required for consumption by the dispatcher (e.g., computer generated voice where a dispatcher is human, in a digital format that can be viewed on a display screen at a dispatcher's computer workstation, etc.). Where detailed rider or motorcycle data for a specific rider is stored by the server 460, server 460 may access some or all of that data and supplement the data received from the on scene phone device 170 with the detailed data and send the supplemented data set to the dispatcher. At block 562 the server 460 monitors for a confirmation that the emergency reporting call was successful and when successful, at block 570, server 460 transmits a confirmation back to the on scene smart phone 170 to be presented to the rider, assuming that phone 170 is in condition to receive the confirmation information. After blocks 562 and 570 control passes on to block 564 where server 460 monitors for a call cancellation from a rider.

Referring again to FIG. 10, where no cancellation is received from a rider, control of the phone 170 passes to block 518 where the phone processor determines if the block 514 timer has timed out. If the timer has not timed out, control loops back up to block 516. Once the timer times out without a call cancellation, control passes up to block 530 as illustrated. At block 516, if a call cancellation is received, the phone 170 transmits a cancel message to the system server 460 and then waits for a confirmation message at block 522.

Referring to FIG. 11, if a cancel message is received at block 564, at block 566 the emergency system server 460 cancels the emergency reporting call and then transmits a cancellation confirmation message back to the on scene phone 170.

Referring to FIG. 10, when a cancel message is received at block 522, control passes to block 524 where a cancel confirmation is presented to the rider via the phone 170 or some other interface device (e.g., a cycle integrated screen, a microphone in a helmet, etc.). Thereafter control passes back up to block 504 where the process continues to loop.

At block 530, a headlight processor 120 continues to collect all data available based on afforded processors including from any headlight camera, headlight or phone microphones, accelerometers, gyroscopes, etc., and may also turn on output devices like speakers so that a dispatcher can communicate with a rider if desired. The connection between the dispatcher and the rider may be maintained at 532 if possible until emergency personnel arrive to help the rider.

It has also been recognized that, in at least some cases, an accident could happen so quickly that a headlight processor or a smart phone device may not be able to initiate an emergency reporting call. For this reason, in at least some cases it is contemplated that a headlight or other on scene processor may be programmed to generate periodic “heart beat” signals that are transmitted to an emergency system server 460 whenever an associated motorcycle is turned on where, when an expected heart beat signal is not received, the server may be programmed to automatically determine that an accident or other emergency may have occurred. For instance, when a rider turns on his motorcycle and a headlight processor 120 pairs with a rider's smart phone device 170, phone device 10 may link with the system server 460 and transmit a heartbeat signal thereto to indicate the start of a driving session. While the motorcycle remains on, processor 120 may transmit a heat beat signal to the server 460 every 10 seconds indicating proper operation of the cycle. In at least some cases an exemplary heart beat signal may include a headlight or motorcycle or smart phone device ID and an instantaneous location of the smart phone device (e.g., figured through a triangulation process or by accessing location information from some other application run on the smart phone).

In addition, the heartbeat signal may indicate a current status of some aspect of the smart phone device 170 such as, for instance, battery charge state. Here, the idea is that server 460 may track phone device conditions that may be responsible for missing anticipated heartbeat signals. For instance, if a phone device 170 battery is substantially discharged and then expected heartbeat signals are missed, server 460 may be programmed to determine that the cause of missing anticipated signals is related to battery condition, not a likely accident.

Here, when an accident occurs and processor 120 and phone device 170 are still in working order and powered, the system would operate as described above to initiate an emergency reporting call. However, if the heart beat signal is missed once or perhaps several times in a row, the system server 460 may automatically initiate an emergency reporting call using the most recently received location information for the specific smart device. Again, in this case, call cancellation options may be presented to a user.

In at least some embodiments it is contemplated that an emergency system server may include a database (not illustrated) where rider and rider vehicle data can be maintained that may be useful for any purpose including for generating a fulsome emergency reporting call, for contacting a primary care physician, friends or family members, etc., when an accident likely occurred.

While systems are described above where, after an initial pairing of a smart device and a headlight assembly, subsequent pairs are automatic, in at least some embodiments it is contemplated that some pairing confirmation step or process may be required to avoid a case where a headlight inadvertently pairs with a wrong smart device. For instance, where first and second people have first and second smart phones in the vicinity of a motorcycle when the cycle is fired up where each of the smart phones was previously paired with a cycle headlight, there is a possibility that the headlight may automatically pair with a wrong smart phone (e.g., the phone of a user that is not going to ride the motorcycle. To avoid this problem in some cases an option to confirm paring may be presented on the display screen of a rider's smart device when the cycle is initially fired up. Once the rider confirms pairing, one of the monitoring and reporting processes described above may be performed.

In some cases smart phone and light pairing may be performed when a cycle is fired up and then a confirmation pairing may be automatically performed at some later time such as 15 seconds after the cycle starts to move, after the cycle has travelled at least 100 feet, or after some other event occurs. Here, the idea is that even if a wrong pairing occurred when the cycle was fired up, the wrongly associated smart device should be outside the near field (NF) pairing range of the headlight processor when the re-pairing occurs and therefore the confirmation pairing attempt should enable the headlight processor to recognize the wrong pairing which can then be automatically corrected. The confirmation pairing may be initiated by the headlight processor 120 or, in some cases, by a smart phone or other smart device.

In at least some embodiments it is contemplated that the headlight processor may be able to automatically cancel an emergency reporting call if the processor can assess that instantaneous conditions or circumstances are highly inconsistent with occurrence of an accident. For instance, if conditions indicate a likely accident but 10 seconds later a motorcycle is up, running and travelling in a controlled fashion at 35 miles an hour on a roadway, the headlight processor may initially start an emergency reporting call and then automatically cancel the call assuming normal operating conditions persist. In other cases where likely accident conditions are followed by likely normal operating conditions the system may require a manual user affirmation that everything is OK and that an emergency reporting call should be cancelled, may set up a 911 to user smart phone call automatically so that a dispatcher can talk to the rider and confirm normal operation, etc.

In some cases a headlight processor may be programmed to operate with other rider worn sensor devices. For instance, a small near field (NF) transmitter (see schematic transmitter 321 in FIG. 7) may be mounted to a rider's helmet 320 where the NF transmitter transmits a heartbeat signal to the headlight transceiver indicating relative proximity (e.g., with 4 feet) between the transceiver and the headlight. Here, if the helmet transceiver heartbeat is suddenly not received by the headlight processor while the motorcycle is traveling at a high speed, that could be used as one tell tail sign that an accident has occurred or is in process. Similarly, wrist worn or other worn devices like smart watches now come equipped with the ability to transmit Bluetooth and other heartbeat signals that may be used in conjunction with a headlight processor 120 to develop data useful in assessing accident likelihood.

While the present disclosure is related to accident reporting systems in most cases, in some embodiments other reporting functions may be supported. For instance, a parent may want to be notified when a child is riding a motorcycle, is travelling at a rate of speed that exceeds a posted speed limit, is heading toward home, is swerving or otherwise driving dangerously, etc. In these cases, it is contemplated that an app may be downloaded to a child's smart phone or other portable computing device or to a motorcycle integrated processor and transceiver where the application receives trigger signals related to the conditions that a parent wants to monitor so that parent notifications or calls can be automatically initiated when specific condition sets occur.

There are several standard sized headlight assemblies that are used in many motorcycle applications including a 7 inch round headlight assembly, a five inch round assembly and some rectangular light assemblies with specific standardized dimensions. Replacement assemblies are contemplated where any of the light assembly features described above may be provided in any one or each of the standard light assembly footprints to facilitate easy replacement and functional upgrades.

While the invention may be susceptible to various modifications and alternative forms, specific embodiments have been shown by way of example in the drawings and have been described in detail herein. However, it should be understood that the invention is not intended to be limited to the particular forms disclosed. For example, while many of the embodiments are described above in the context of a headlight assembly including a processor and transponder, it should be appreciated that the headlight assembly components that are in addition to normal headlight assembly components may be provided in other motorcycle sub-systems. For instance, all of the FIG. 1 headlight assembly components except the optics and light devices represented by assembly 140 may be packaged in a tail light assembly either as original equipment or where the light assembly is a replacement assembly.

As another example, while the emergency reporting headlight assemblies are described above in the context of a motorcycle, it should be appreciated that other headlight assemblies may be provided for use in other vehicles like utility vehicles, all-terrain vehicles, three wheel cycles, automobiles, trucks, vans, etc. Here, the algorithms for assessing likelihood an accident occurred may be different in an automobile or the like.

As another example, in most of the embodiments above much of the emergency detecting process or processes used to assess likelihood of an accident are described as performed by the headlight processor 120. In some cases some of those process steps or even most of those steps may be performed by a portable smart device processor or the like where the headlight simply collects condition and circumstance data and transmits that data to a rider's smart device for processing.

In the systems described above a processor determines likelihood that an emergency condition exists. Here it is contemplated that an emergency reporting call will only be initiated when the likelihood of an emergency condition exceeds some threshold level (e.g., 10% or 20% chance emergency conditions exist). In some cases there may be two thresholds, a first low threshold where an emergency reporting call will be initiated imminently if a rider does not cancel the call in some short duration of time and a second high threshold where an on scene processor automatically initiates a reporting call immediately upon detecting that the second threshold has been met. For instance, the first low threshold may be 5-20% likely that emergency conditions exist in which case, if a reporting call is not cancelled or disabled, the call is initiated 30 seconds after a query is presented to a rider asking if the call should be disabled, and a second high threshold may be 30% or greater in which case an immediate reporting call may be initiated.

Thus, the invention is to cover all modifications, equivalents, and alternatives falling within the spirit and scope of the invention as defined by the following appended claims.

To apprise the public of the scope of this invention, the following claims are made:

What is claimed is:

1. A headlight assembly for use in a vehicle and for reporting emergency conditions to a dispatcher, the headlight assembly comprising:
a housing forming a cavity;
a processor mounted in the cavity;
a wireless transceiver supported by the housing and linked to the processor;
at least a first sensor device for sensing at least a first condition while the vehicle is operating, the first sensor device in communication with the processor;
wherein the processor is programmed to:
(i) receive data from the at least a first sensor device;
(ii) analyze the received data to assess likelihood that an emergency condition exists; and
(iii) upon determining that likelihood of an emergency condition is greater than a first threshold level, automatically initiating a wireless emergency reporting communication with an emergency dispatcher.

2. The assembly of claim 1 wherein the first sensor device is at least one of an accelerometer, a gyroscope and a speedometer.

3. The assembly of claim 1 wherein the wireless transceiver is a near field transceiver and wherein the processor initiates a wireless emergency reporting communication by transmitting a near field trigger signal.

4. The assembly of claim 3 for use with a user's portable computing device wherein the portable computing device includes a near field transceiver and a second wireless transceiver, the portable computing device receiving the near field trigger signal from the headlight assembly and in response initiating an emergency reporting communication to the emergency dispatcher.

5. The assembly of claim 4 wherein the processor is further programmed to generate a confirmation signal subsequent to transmitting the trigger signal.

6. The assembly of claim 5 further including a rider interface device that generates a confirmation indication in response to the confirmation signal.

7. The assembly of claim 6 wherein the portable computing device includes the interface device.

8. The assembly of claim 6 wherein the confirmation indication is one of an audible signal, a visual signal and a haptic signal.

9. The assembly of claim 6 wherein the confirmation indication includes a cancellation query inquiring if the emergency reporting communication should be cancelled.

10. The assembly of claim 1 wherein the processor continues to collect data from the at least a first sensor device subsequent to automatically initiating the emergency reporting communication.

11. The assembly of claim 10 wherein the at least a first sensor device includes at least one of a camera and a microphone.

12. The assembly of claim 1 wherein the at least a firs sensor device includes a plurality of different types of sensor devices.

13. The assembly of claim 1 for use with at least one rider wearable sensor device, the wearable sensor device generating sensor data that is transmitted to the processor and used by the processor along with the first sensor device data to assess likelihood that emergency conditions occur.

14. The assembly of claim 3 for use with an integrated computing device that is integrated into the vehicle wherein the integrated computing device includes a near field transceiver and a second wireless transceiver, the integrated computing device receiving the near field trigger signal from the headlight assembly and in response initiating an emergency reporting communication to the emergency dispatcher.

15. The assembly of claim 14 wherein the integrated computing device includes a memory device on which an emergency reporting application is loaded as well as a display screen on which emergency reporting communication status notifications are presented to a rider.

16. The assembly of claim 1 wherein the transceiver is a cellular transceiver, the step of automatically initiating a wireless emergency reporting communication with an emergency dispatcher including initiating a wireless cellular call to the emergency dispatcher via the cellular transceiver.

17. The assembly of claim 4 wherein the portable computing device includes an interface and wherein the portable computing device presents an emergency reporting communication cancellation option to a rider.

18. The assembly of claim 1 wherein the emergency reporting communication includes at least identity of the rider and location of the vehicle.

19. The assembly of claim 4 wherein the portable computing device determines location of the portable computing device and wherein the emergency reporting communication includes the location of the portable computing device.

20. The assembly of claim 3 wherein the near field transceiver is a Bluetooth transceiver.

21. A headlight assembly for use in a vehicle and with a rider's wireless portable computing device, the assembly for reporting vehicle conditions, the headlight assembly comprising:
a housing forming a cavity;
a processor mounted in the cavity;
a wireless transceiver supported by the housing and linked to the processor;
at least a first sensor device for sensing at least a first condition while the vehicle is operating, the first sensor device in communication with the processor;
wherein the processor is programmed to:
(i) receive data from the at least a first sensor device; and
(ii) wirelessly transmit the received data to the portable computing device.

22. A system including the headlight assembly and the portable computing device of claim 21 wherein the portable computing device includes a second processor that is programmed to analyze the received data to assess likelihood that an emergency condition exists and, upon determining that likelihood of an emergency condition is greater than a first threshold level, automatically initiating a wireless emergency reporting communication with an emergency dispatcher.

23. An emergency reporting system for use in a vehicle and for reporting emergency conditions to a dispatcher, the emergency reporting system comprising:
(A) a headlight assembly including:
a housing forming a cavity;
a first processor mounted in the cavity;
a first near field wireless transceiver supported by the housing and linked to the first processor; and
at least a first sensor device for sensing at least a first condition while the vehicle is operating, the first sensor device in communication with the first processor;
(B) a wireless portable computing device including:
a second processor;
a second near field wireless transceiver linked to the second processor; and
a third wireless transceiver;
the first processor programed to:
(i) receive data from the at least a first sensor device;
(ii) analyze the received data to assess likelihood that an emergency condition exists; and
(iii) upon determining that likelihood of an emergency condition is greater than a first threshold level, automatically transmit a trigger signal to the second near field transceiver to initiate an emergency reporting communication;
the second processor programmed to:
(i) upon receiving a trigger signal from the first processor, initiate an emergency reporting communication with an emergency dispatcher via the third transceiver.
